(19) United States
(12) Patent Application Publication
(10) Pub. No.: US 2016/0088222 A1
(43) Pub. Date: Mar. 24, 2016

(54) SYSTEM AND METHOD FOR MERGING A PLURALITY OF SOURCE VIDEO STREAMS

(71) Applicant: GOPRO, INC., San Mateo, CA (US)

(72) Inventors: Alexandre Jenny, Challes-les-Eaux (FR); Renan Coudray, Montmelian (FR)

(73) Assignee: GOPRO, INC., San Mateo, CA (US)

(21) Appl. No.: 14/957,450

(22) Filed: Dec. 2, 2015

Related U.S. Application Data
(63) Continuation of application No. PCT/EP2014/061897, filed on Jun. 6, 2014.

(30) Foreign Application Priority Data
Jun. 7, 2013 (FR) 1355282

(51) Int. Cl. H04N 5/232; H04N 5/265

(52) U.S. Cl. CPC H04N 5/23238; H04N 5/265

(57) ABSTRACT

System and methods are disclosed for stitching a plurality of video streams to generate a wide field video stream. The wide field video stream may be created by obtaining multiple video streams that correspond to a common period in time at which portion of the multiple video streams were captured. A reference instant the pertains to a common period of time order may be determined to help stitch the images corresponding to the video streams in chronological order. A reference value is then calculated for a construction parameter of one or more images from the multiple video streams captured at times that correspond to the determined reference instant. A panoramic image is then constructed by stitching together the images that correspond to the determined reference instant, thus further generating a wide field video stream.

### FIELD OF THE INVENTION

An apparatus and methods described herein generally relate to merging a plurality of video data files to create a wide field video stream.

### BACKGROUND OF THE INVENTION

Existing cameras make it possible to generate a video data file of a video filmed by video cameras. Additionally, video cameras can be assembled in numerous directions to film multiple angles and viewpoints so as to simultaneously film a particular environment exceeding the human field of vision. When assembling the various complementary films corresponding to the environment exceeding the human field of vision, the video assembly may result in a wide field video stream.

However, merging or stitching the complementary films to create a wide field video stream is not an easy task with current existing solutions. For example, merging or stitching the various video films so as to generate a single wide field video stream file often results in a low quality video file. Additionally, the stitching of the plurality of corresponding video films requires numerous and extensive manual operations by a user, and often a plurality of software tools that are not compatible with one another, thus requiring significant time and manual labor.

### SUMMARY

In light of the above-described drawbacks associated with merging a plurality of video source streams, there is a need for an improved solution that does no exhibit all or some of the drawbacks associated with current existing systems and methods for merging or stitching a plurality of source video streams to create a wide field video stream.

Embodiments of the disclosed technology are directed towards a system and method for merging a plurality of video source streams to generate a corresponding wide field video stream. The disclosed embodiments include at least a partial automatic optimization for merging, or stitching, the various video source streams that guarantees at least a generated wide field video stream from a video stitching device. Additionally, other embodiments may include a human-machine interface so as to allow a user to manually override the automatic optimization operations, thus further allowing a user-friendly operating system to create and modify a wide field video stream.

In some embodiments, a method for stitching a plurality of video streams may include obtaining multiple video streams that correspond to a common period of time that were filmed and captured on a camera. The temporal offset of the multiple video streams may be measured with respect to time so that the multiple video streams are synchronized by associating the images captured at proximate times within the various video streams. In some embodiments, the temporal offset may be measured by identifying the soundtrack associated with the various video streams such that the identified sounds are used to synchronize the multiple video streams.

A reference instant may then be determined such that a reference instant may be defined in a chronological matter, such as a reference point in time to aid in the stitching of the plurality of video streams. The determination of the reference instant may be determined by manual selection based on the selection of an operator or by automation via the processor of the stitching device.

Upon the determination of the reference instant within a common period time, the construction parameters of one or more images corresponding to the determined reference instants of the multiple video streams results in a calculated reference value. In other words, a reference value is the construction parameters associated with the determined reference instants and is further stored for subsequent application when stitching the video streams. In addition, the calculation of the reference value of the construction parameters at the reference instant may further include modifying the construction parameters that correspond to at least two different viewpoint orientations in order to ensure that horizon in the wide field video stream is stable. In further embodiments, the construction parameters may be held constant for the duration of the stitching of the multiple video streams. Additionally, at least one of the construction parameters may vary for at least a portion of the duration of the stitching in the multiple video streams.

A mathematical interpolation based on at least two reference values of the construction parameter may be calculated at two different reference instants in order to obtain a continuous progression of time with respect to at least one construction parameter. The mathematical interpolation may include linear, Bezier, cubic, spline, or b-spline interpolation.

The method of stitching a plurality of video streams may further include selecting a panoramic image construction algorithm that defines a plurality of geometric and radiometric construction parameters. Based on the selected panoramic image construction algorithm, a reference value at a first reference instant and other reference instants may be determined based on the reference values of the construction parameters. The generated video streams from the corresponding panoramic images may be stitched in accordance to the same reference instant. In other instances, the construction of the panoramic images may be generated by using the reference values of the construction parameters at different reference instants. The generated wide field video stream may then be displayed on a display space of at least one screen.

A device for stitching a plurality of video streams may include a processor, a non-transitory computer-readable medium operatively coupled to the processor and storing instructions that, when executed, cause the processor to obtain multiple video streams that correspond to a common period in time at which portions of the individual streams were captured. Additionally, the processor may be further configured to construct a panoramic image by stitching together the images of the multiple video streams corresponding to the determined reference instant, such that the stitching is based on the calculated reference value of the construction parameter.

The stitching device may further include a first window for presenting the various video streams to be stitched, a second window for viewing the panoramic image resulting from the stitching of the images of the various video streams at a determined reference instant, a select area for inputting the determined reference instant, and a third window for presenting the generated wide field video stream. In further embodiments, an integrated viewer may be included to view the generated wide field video stream on a screen of the stitching device.

These and other objects, features, and characteristics of the present disclosure, as well as the methods of operation and functions of the related components of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the any limits. As used in the specification and in the claims, the singular form of “a”, “an”, and “the” include plural referents unless the context clearly dictates otherwise.

### BRIEF DESCRIPTION OF THE DRAWINGS

FIG. 1 illustrates a device for stitching a plurality of video source streams, in accordance with one or more implementations.

FIG. 2A illustrates a method configured for stitching various video source streams, in accordance with one or more implementations.

FIG. 2B illustrates a method configured for stitching various video source streams, in accordance with one or more implementations.

FIG. 2C illustrates a method configured for stitching various video source streams, in accordance with one or more implementations.

FIG. 3 illustrates a graphical human interface screen for stitching various video source streams on a stitching device, in accordance with one or more implementations.

FIG. 4 illustrates an example computing module that may be used to implement features of various embodiments of the disclosure.

### DETAILED DESCRIPTION

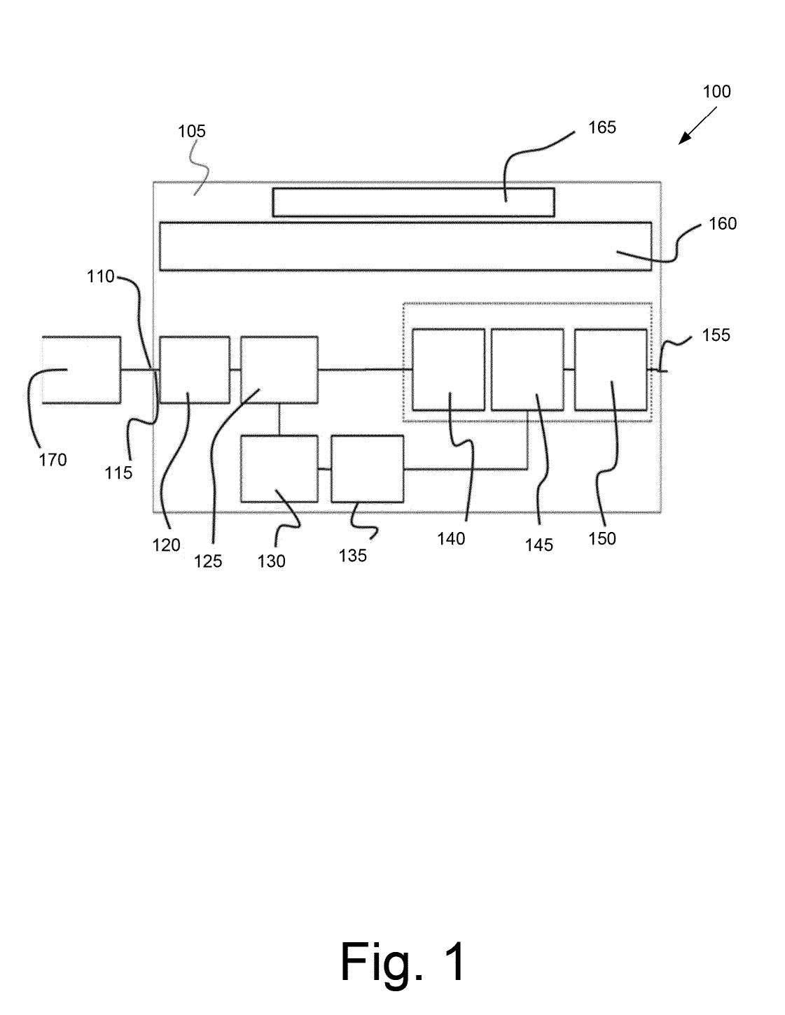

FIG. 1 illustrates a device for stitching a plurality of video source streams, in accordance with one or more implementations. In some implementations, as illustrated in the exemplary stitching device 100, an input connector 110 is configured to upload various source video stream files originating from a one or more cameras 170. The input connector 115 is connected to the stitching device 100 via communication means 110 that receives and processes the various source video stream files. By way of example only, the input connector 115 may include a Universal Serial Bus port. Accordingly, the processor 165 may include logic circuits for receiving, processing, and/or storing information received via the communication means 110 and the uploaded source video stream files from the one or more cameras 170. Additionally, the processor 165 may further store the processed source video stream files in memory storage so that the uploaded or modified source video stream files may be stored and processed.

The various video stream files may be generated by a plurality of cameras 170 fasted to a multi-camera holder, or otherwise known as a “rig.” A rig may include multi-camera holder where the axes of the field of vision of at least two adjacent cameras are oriented in a substantially perpendicular direction so that the cameras 170 are able to film a plurality of views of a particular environment. Moreover, the various cameras 170 on the rig can be considered to be fixed with respect to one another. In other embodiments, the stitching device 100 may receive and process any number of video source streams originating from any number of cameras 170 on one or more camera holders.

As further illustrated, an temporal offset detector 120 is configured to detect the temporal offset between the various video source streams received and detected by the communications means 110 of the input connector. The temporal offset detector 120 may distinguish and separate the temporal reference of the multiple cameras 170 used to create various video stream files for creating the wide field video stream. In some embodiments, the multiple cameras 170 mounted on a multi-camera holder may each be operated with an independent internal clock, thus rendering the various video stream uploaded to the stitching device 100 to be offset in time. This temporal offset of the various video source streams may be further due to the different internal clock settings of the multiple cameras 170 used to film the various video streams. Thus, the temporal offset detector 120 may be used to detect the temporal offset between any two or more video stream files uploaded onto the stitching device 100.

In some embodiments, the temporal offset may be determined via the identification of the soundtrack of the various video source streams. Specifically, the temporal offset detector 120 may recognize and identify the identical sounds in the various video streams and deduce therefrom the temporal offset. In accordance to one particular embodiment, the time period in which the temporal offset detector 120 may identify the sounds of the video stream soundtracks are manually indicated and determined by an operator. In other instances, the identified sounds of the soundtrack of one or more video streams may be automatically determined by the temporal offset detector 120.

In some embodiments, the stitching device 100 can utilize the temporal offset detector 120 to implement an automatic diagnosis of the measured temporal offset by automatically measuring the quality of the resetting obtained. As such, the temporal offset detector 120 may detect possible incoherencies between all the offsets calculated for all the combinations of at least two video streams from among the set of video streams considered. Upon the result of the automatic diagnosis, the obtained result may be transmitted to an operator via a human-machine user interface so that the operator may determine whether the result is satisfactory or unsatisfactory through a comparison with a predefined threshold. The human-machine interface may include a graphical human interface screen 160 so that an operator may select and view the results to determine whether the result is visually satisfactory. Upon visual inspection on graphical human interface screen 160, a new temporal offset may be determined in the case the result should be deemed inadequate.

In other embodiments, the stitching device 100 may be further configured to include a synchronizer 125 so that the various video streams may be synchronized by time. The synchronization of the various video streams may include an operation of the inverse offset of the video source streams so as to best synchronize them by time. Accordingly, a first stream is chosen as a reference video stream. Preferably, the first stream chosen as the reference video stream is the video source stream having started last in time so that the other video streams are then synchronized with the selected reference video stream. Accordingly, the offset time obtained by the temporal offset detector 120 may be further used to deduce therefrom each of the video stream the number of offset images with respect to the reference video stream. As such, the output from the synchronizer 125 may include a set of images corresponding to the various video streams closest in time. Accordingly, each video stream can be inversely offset by the number of offset images so as to obtain its synchronization with the reference stream. By way of remark, the images of each video stream may however remain slightly mutually offset, and therefore not perfectly synchronized. However, the residual offset may be minimized by the synchronizer 125. Moreover, the soundtrack of each video stream may additionally be offset by the same offset time as the video streams associated with the audio and thus may be synchronized based on the identified sounds of the soundtrack.

In other embodiments, the stitching device 100 may receive video source streams that are already synchronized by other means outside the stitching device 100. By way of example, sophisticated cameras with a common internal clock may time stamp the input video streams such that the video streams are already synchronized by time and do not require synchronization via the synchronizer 125. However, utilizing synchronizer 125 is strongly advised, or indeed required, in order to obtain a high quality video stream output from the stitching device 100.

In some embodiments, a reference instant is defined at the reference instant configurator 130 of the stitching device 100. By way of example, the reference instants may be defined in a chronological manner and may be a reference point in time to aid in the stitching of the plurality of video streams. The first reference instant may be chosen at the start of the duration of the video stitching, where the first instant may be propitious to the calculations implemented from a first panoramic image from combining the images of the of the various video streams at determined first instant. The term panoramic image is used to refer to an image obtained from grouping or stitching a plurality of images, such that a wide angle view of the selected environment is depicted. Thereafter, a second instant may be chosen when the conditions of the various video streams are substantially modified.

In one particular embodiment, the reference instant configurator 130 may determine a first reference instant by manual determination. In this particular instance, the operator may manual select the reference instant by visual determination via a screen 160 of a graphical human-machine interface. In other embodiments, the reference instant configurator 130 may automatically determine the reference instants. By way of example only, the reference instants may be automatically determined by the detection of particular events, such as change in brightness in at least one video stream and/or appreciable motion of the cameras entailing a change in the three dimensional frame. The thresholds for the detection of particular events can be predefined for each of the criteria so that the reference instant may be retained until the instant at which the criterion exceeds the threshold.

The threshold for making it possible to retain a reference instant is adjustable as a function of the desired number of reference instants. In some embodiments, there will be at least two reference instants over the entire duration of the stitching of various video streams. Preferably, the number of reference instants chosen is at the minimum in order to achieve a satisfactory visual quality such that any improvement in the video quality would be imperceptible to the human eye. However, the number of reference instants further may depend on the number and quality of the video streams, and thus cannot be predetermined or predefined. However, it is noted that in most cases, a maximum of one reference per second may suffice. As such, the choice depends naturally on the source video streams and the particular conditions of the stitching of the various video streams to be processed by the stitching device 100.

Furthermore, upon the determination of the reference instant, a panoramic image constructor 135 of the stitching device 100 may be configured to define a plurality of parameters, or otherwise known as construction parameters. When the parameters are determined, a calculation algorithm is used to group the images corresponding to the various video streams so as to from a single image of a larger format, or otherwise known as a panoramic image. Accordingly, the determined calculation algorithm may be further utilized in particular to manage intercut zones of the various images corresponding to the various video streams. Additionally, the panoramic image constructor 135 may also process the boundary zones between the images originating from the various cameras so as to guarantee a continuous and visually indiscernible boundary when a panoramic image in constructed. More specifically, a pixel of an intercut zone may be constructed on the basis of the information originating from a plurality of cameras, and not through a single camera. As such, a simple juxtaposition of films does not indeed represent a stitching within the meaning of the invention.

Furthermore, the construction parameters include geometric and radiometric parameters that are further calculated by the construction algorithm. By way of example only, the construction parameters used by the construction algorithm may include the following: extrinsic parameters of the cameras; relative positions and/or orientation of the camera; intrinsic parameters of the cameras, such as the distortion, the focal length, the sensor/lens axis alignment; global position of the multi-camera holder with respect to a benchmark (i.e., horizon); the color and/or brightness correction; the masking of the defects; and the projection of the output video. As such, the use of the term panoramic image construction hereon refers to the set of all the parameters used by the chosen algorithm for constructing a panoramic image. The principle of the invention is suitable for any type of panoramic image construction algorithm. However, when a construction algorithm is chosen, it is used over the entire duration considered of the stitching of the source video streams. Thus, the set of construction parameters is defined and remains unchanged over the entire duration of the stitching, and only the value of one or more of these parameters is subject to change.

The parameters of the panoramic image construction make it possible to achieve spatial coherence between the various images originating from the various video stream at a given instant, such as a determined reference instant. However, to guarantee the achieving of coherence of wide field video stream resulting from the stitching of the various video streams, it is necessary to ensure that the temporal coherence between the various constructed panoramic images are properly assembled to from a wide field video stream. As such, the panoramic image construction algorithm defines the values of the construction parameters, and then implements a scheme for achieving temporal coherence during the stitching of the source video streams. As such, there is a controlled evolution over time of the values of these construction parameters.

In accordance to this particular embodiment, this evolution pertains to the necessary minimum number of values of construction parameters that need to be modified from the set of construction parameters in order to achieve satisfactory temporal coherence and a high quality video output. Furthermore, this particular embodiment further eliminates the need for the reference values of the construction parameters to be recalculated for each panoramic construction. However should the reference parameters be recalculated for each panoramic construction, significant power and calculation would be required without the successful guarantee of creating a successful panoramic image. Indeed, the resulting wide field video stream would even likely exhibit problems of temporal incoherence, with clear visible jumps within the video stream, thus creating an unsatisfactory video quality output.

In the instance that the cameras 170 corresponding to the various video stream files do not remain fixed with respect to one another and/or one or more objects, the construction parameters calculated at the first instant may no longer automatically be suitable for obtaining an optimal panoramic image at a second instant that is coherent with the first panoramic image obtained at the first instant. Indeed, the displacements, by way of example only, may be caused by any offset with respect to the horizon or sudden changes in the brightness sensed by the camera 170 (i.e., in the instance the camera 170 is suddenly facing the sun, etc.), which may give rise to degradation, instability, and/or incoherent visual rendition in the instant that the construction parameters 140 fail to take such phenomena into account.

Referring back to the determined reference instant determined by the reference instant configurator 130 that corresponds to a common period of time, an operator may manually input the determined reference instant via a human-machine interface. In such an embodiment, the operator may view the various source video streams and visually detect certain changes at certain instants, thus further making it possible to define the reference instant suitable in conjunction with the determined construction parameters.

In another embodiment, the determination of the reference instants by the reference instant configurator 130 may be instead automatically detected in correspondence to particular events, according to criteria such as the changes in brightness of at least one source video streams or changes in appreciable motion of the cameras pertaining to changes in a three dimensional frame. Thresholds can be predefined for each of these criteria so as to determine automatically whether the reference instant may be retained at the instant based on the established criteria.

Upon the determination of the reference instants, each panoramic construction parameter at each reference instant may then be diagnosed, either automatically or manually by visual determination on a graphical human-machine interface screen 160. In the instance that the diagnosis is not ideal, the reference instant may be modified either automatically by a processor 165 or manually by an operator until a more favorable panoramic construction algorithm is used. When the result is then satisfactory for each instant, the reference values associated with these reference instants of the construction parameters are stored for subsequent application to the stitching of the source video streams. Hereon, the reference value of the panoramic image construction parameter at a reference instant will now be referred to as the reference construction parameter.

In other embodiments, the reference instant of the corresponding reference construction parameter can be obtained by selecting each reference instant and then calculating the associated reference construction parameters before choosing the subsequent reference instant. To choose this subsequent reference instant, a subsequent reference instant may be determined automatically or by manual visual determination by an operator, as described above.

In the instance that the reference instant and the corresponding reference construction parameter is automatically determined, the one reference instant may be chosen in a random manner. In other instances, a predefined reference instant may be distributed in a random manner or in accordance to a homogenous distribution over the duration of the stitching to be carried out. Additionally, the wrongfully determined reference instant determinations may be discarded. In a more elaborate approach, the modifications of the source video streams may be qualitatively and objectively determined based on a predetermined criteria.

In accordance with yet another embodiment, the large number of reference instants may be chosen automatically in accordance with a predefined period for all or part of the duration of stitching the various video streams. Thereafter, a step of combining the various results obtained from the construction parameter calculated over a plurality of chosen reference instants may then be implemented. In other words, the reference values of the construction parameter may be obtained by grouping a plurality of reference values of the construction parameters obtained at different instants. This combining consists of an average of the reference values for the various panoramic construction parameters, where the average is an arithmetic, geometric, or a mathematical function making it possible to deduce a reference value for each construction parameter.

In accordance to yet another embodiment, an operator or a processor 165 may determine a reference instant to implement a step of calculating a construction parameter over a plurality of instants chosen over a time span distributed in the nearby reference instant. This time span can be determined by parameters that are predefined previously or input by the operator via a human-machine interface. Thereafter, the panoramic image construction reference parameters may be finally determined by combining the various parameters obtained for each of the instants chosen over the determined time span.

Referring back to FIG. 1, after determining the reference construction parameters via the panoramic image constructor 135 of the stitching device 100, the stitching device 100 then further proceeds to obtain a single video stream by aggregating the video data from the various video stream input into the stitching device 100. Thus, after determining the reference construction parameters, the stitching device must now group or stitch the plurality of panoramic images in order to create a wide field video stream. As such, a panoramic image must first be constructed on the basis of the image of each video stream corresponding to the given instant considered. In order to do so, decoder 140 may first decode the image or a plurality of images corresponding to a given instant or proximate to the reference instant. By way of remark, the decoding of the images makes it possible to transform the data of the video streams which are initially in a standard video format (i.e., MPEG, MP4, etc.) to a different format required for stitching the various video streams as recognized by the processor 165 of the stitching device. Upon the determination of the reference instants, decoder 140 of stitching device 100 may be configured to decode the images corresponding to each source video stream at the determined reference instant. The decoded images are then stored in a memory of the device for their processing in the following steps. By way of remark, only a partial decoding is undertaken and preferably a restricted partial decoding (i.e., fewer than ten images, or three or fewer per video stream) of the images because in such an instance, processor 165 does not demand a large memory size when processing the images. Indeed, each video streams possesses a reasonable video size in its coded standard format when integrated in a data compression scheme, but then occupies a much greater memory size when in a decoded format.

Next, stitching device 100 may proceed to image stitcher 145, where the image stitcher 145 constructs a the panoramic images at a given reference instant. As explained above, the construction of a panoramic image is carried out with the aid of the reference construction parameter, further allowing fast construction of the panoramic image. Accordingly, as discussed above, the reference construction parameters were defined at the reference instants. To deduce therefrom the values of the construction parameters for all the instants to be used for all the constructions of panoramic images, especially those other than at the reference instants, a mathematical interpolation calculation is carried out in order to join the reference construction parameters in a progressive and continuous manner. As such, this scheme allows the construction parameters to be defined over time through a continuous function.

For the implementation of the mathematical interpolation, any one of the following mathematical approaches can be used automatically: linear, Bezier, cubic, Spline, b-Spline, etc. By way of remark, the selection of the interpolation scheme may be manually selected by an operator through the screen 160 of the graphic human-machine interface. Thus, if the results do not visually satisfy an operator, the operator can recommence the stitching of the video stream while modifying the interpolation scheme. In some embodiments, the interpolation is carried out for each of the construction parameters of the construction parameters. When the construction parameters are modified, the corresponding values of the construction parameters are then varied over time.

In accordance to one embodiment of the invention, the mathematical interpolation can be carried out in an independent manner for each construction parameter. In general, certain construction parameters remain constant, thus not requiring any calculation, whereas others may vary and require mathematical interpolation as described above. Moreover, among the construction parameters whose value changes, the amplitude of the change may be very different, and thus may further require different mathematical interpolations.

In some embodiments, the mathematical interpolation of certain construction parameters can be performed over the entire duration of the video stitching at all the reference instants or may be performed at determined time intervals only.

In accordance with one embodiment of the invention, the construction parameters at a given instant are chosen by taking the reference construction parameters values determined at the closest lower reference instant. In the instance that the certain construction parameter changes at the next reference instant, or at any subsequent reference instant, a value resulting from a mathematical interpolation is obtained at such instances that are proximate in time to the particular reference instant. In some embodiments, the reference value of the construction parameter is retained at a constant at the reference instant in case the next reference instant is further away than a certain determined threshold. As such, the mathematical interpolation is reserved over a time interval not yet reached.

The progressive calculation by the interpolation of the construction parameters are implemented for each instant outside the reference instant or retains the same reference construction parameters for a determined duration and then implements one or more interpolations over another specified duration.

As such, the determined panoramic image construction algorithm allows the values of all or some of the reference values of the construction parameters to be calculated and optimized for certain reference instants. Such reference values of the panoramic construction parameter are moreover established by the panoramic image construction algorithm on the basis of the source video streams to be stitched. Additionally, the values of the construction parameters are calculated for the other instants outside the reference instants on the basis that one or more reference values calculated at the reference instants without implementing the construction algorithm for constructing the panoramic images. This then allows the stitching device 100 obtain a simpler and faster calculation while guaranteeing spatial and temporal coherence of a generated wide field video stream.

As such, a high quality wide field video stream results at the determined reference instants, for which the values of the construction parameters have been particularly optimized. Furthermore, the wide field video exhibits temporal coherence since the construction parameters are modified over time to adapt to the variations situations that occur while filming the various video streams. For example, a stable horizon in the resulting wide field video stream may be generated, even in the instance that the horizon of the environment changes when being filmed with respect to the camera 170 or vice versa, the camera 170 changes its orientation with respect to the horizon. It will be appreciated by those skilled in the art that the horizon can be kept stable in the resulting wide field video stream by modifying two construction parameters used by the panoramic image construction algorithm: “yaw” and “pitch.” In this particular example, yaw and pitch represent two angular orientations of the multi-camera holder in a spherical frame. In further embodiments, a third orientation parameter known as a “roll” may be included. However, the changing of two or three construction parameters corresponding to extrinsic parameters relating to orientation suffices to guarantee that the horizon is kept stable in the resulting wide field video stream even when the horizon is unstable during filming.

Referring back to FIG. 1, the encoder 150 makes it possible to form the output wide field video stream in a chosen standard video format (i.e., MPEG, MP4, H264, etc.). As such, the generated wide field video stream may be transmitted by output 155 of the stitching device 100. In some embodiments, a graphical human interface screen 160 is implemented on the stitching device 100 allowing a reader to possibly visually view the wide field video stream on a screen.

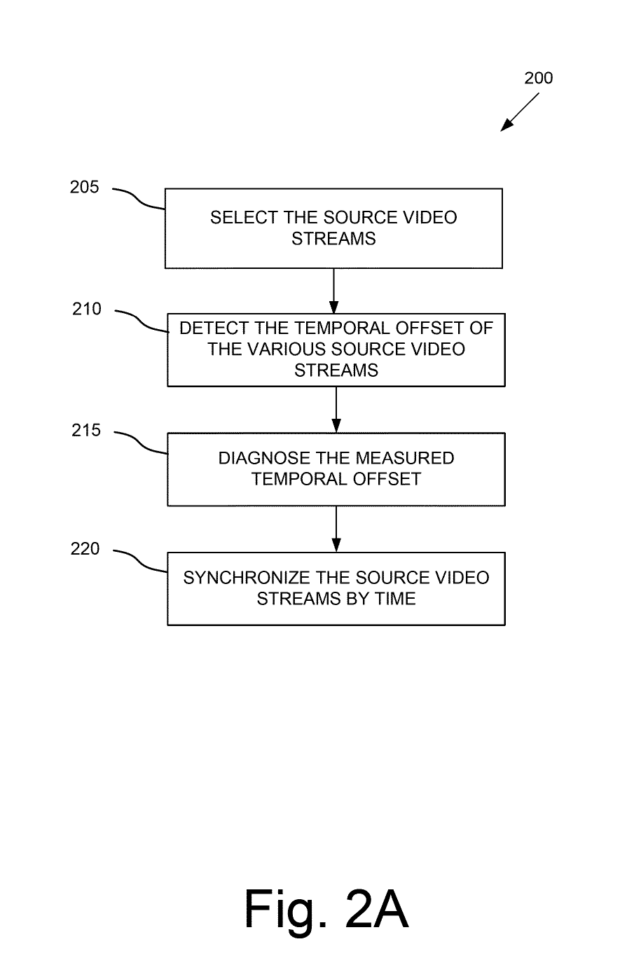

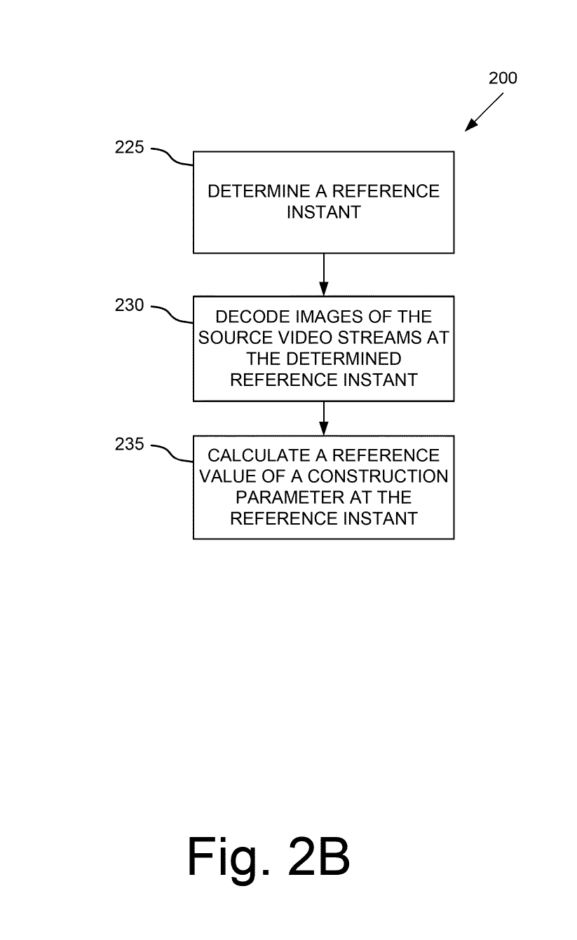

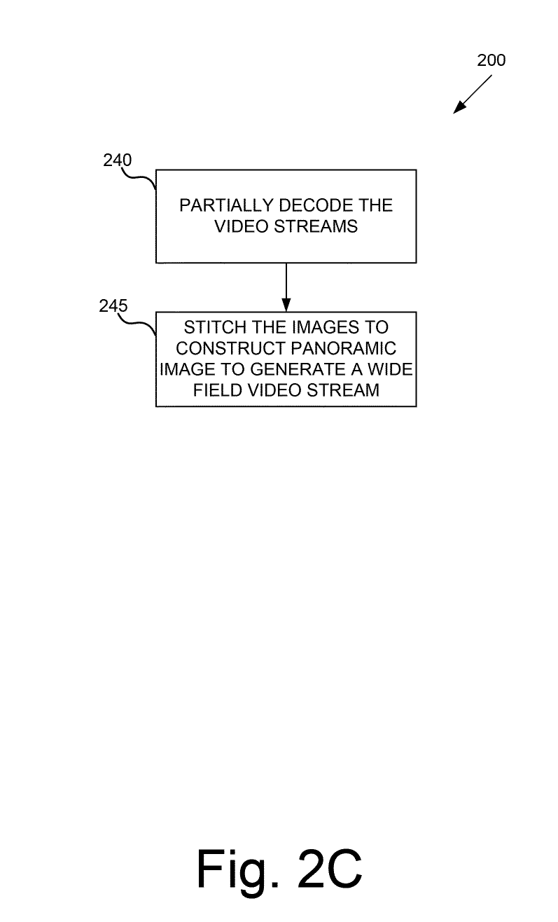

FIG. 2A-2C illustrates a method configured for stitching various video source streams, in accordance with one or more implementations. Specifically, FIG. 2A illustrates selecting and preparing the various source video streams to be stitched or merged into a wide field video stream. At operation 205 of method 200, the source video streams filmed by various cameras are uploaded into a stitching device. As an optional operational step, an operator may select a fixed start and end instant of the wide field video stream to be generated, which thus indicates the start and end of the stitching instants. Next, at operation 210, the temporal offset may be detected and measured for the various source video streams. In other embodiments, the detecting and measuring the temporal offset may include using the soundtrack associated with the various source video streams to identify identical sound in order to aid in determining the temporal offset of the various source video streams. In accordance to one embodiment, the search for a particular sound to deduce therefrom the offset of at least two or more source video streams is limited about a reference time indicated by an operator. In other embodiments, the search for a particular sound within a soundtrack is entirely automatically determined by the stitching device, as discussed in FIG. 1, and can be carried out over the entire duration of the selected source video streams.

Next, optional operation 215 of method 200 includes diagnosing the measured temporal offset. Diagnosing the measured temporal offset can detect possible incoherencies between all or some of the offsets calculated for all the combinations of at least two video streams. The method can further transmit the result of the diagnosis to an operator through a graphical human-machine interface, such as the screen of the stitching device by way of example only. In some embodiments, the stitching device may automatically determine whether the result is satisfactory or unsatisfactory by comparing an exemplary predefined threshold. In the instant the diagnosis is unsatisfactory, the stitching device may implement a new offset calculation.

At optional operation 220, the source video streams may then be synchronized based on a selected reference video stream. In a preferred embodiment, the reference stream is the video stream having started last in time, such that each other video stream in synchronized according to the determined reference stream. Each video stream synchronized may be inversely offset by the number of offset images so that the video streams are synchronized with the determined reference stream. Although the images of each video stream may be slightly offset in time even after synchronization at operation 220, the residual offset is minimized by these synchronizing steps. In further embodiments, the soundtrack of each video stream may be offset by the same time so that that the audio in the video streams are also synchronized. Operation 210-220 may be optional since the source video streams inputted in the stitching device may already by synchronized by some other means outside the stitching device. For example, the video streams may already be synchronized in the instance that the corresponding cameras used to film the video streams include a common internal clock. In such a case, synchronization among the video streams within the stitching device may no longer be necessary since the video streams already correspond to one another via a common time source. However, utilizing operation 210-220 may be strongly advised in order to obtain a sufficient quality video stream at the output of the stitching device.

FIG. 2B illustrates a method for stitching a plurality of video streams utilizing a reference instant. At operation 225 of method 200, a reference instant is determined. A reference instant may be defined in a chronological manner and a plurality of reference instants may be defined over the duration of the video stitching to be carried out. The first reference instant may be chosen toward the start of the duration of the video stitching. The first reference instant may be propitious to the calculations implemented to form a first panoramic imaged by combining the images of the source video streams corresponding to the first reference instant. Thereafter, the second reference instant may be chosen when the conditions of the source video streams are substantially modified.

To input a determined reference instant into the stitching device, the reference instant may be determined by manual imputation by an operator. As such, the operator may input a determined reference instant via a graphical human-machine interface. In such an embodiment, the operator can further view the various source video streams and visually detect certain changes at certain instants, thus making it necessary to define a suitable reference instant. In other embodiments, a reference instant may be automatically determined by the stitching device, as discussed above in relation to FIG. 1.

Next at operation 230 of method 200, images of each source video stream corresponding to the reference instant may be decoded. The decoding makes it possible to transform the data of the video stream that are initially in a standard video format (i.e., MPEG, MP4, etc.) to a different format suitable and recognized by the processor of the stitching device.

Next, at operation 235 of method 200, a reference value of a construction parameter at the reference instant is calculated. The calculated reference value of a construction parameter captures the one or more images from the video streams that correspond to the determined reference instant.

FIG. 2C illustrates a method for stitching a plurality of video streams with the selected reference parameters at the determined reference instants, as described in FIG. 2B. At operation 240, images or a plurality of images for each video stream at a given instant, or around the given instant is decoded. The decoded images are stored in a memory of the stitching device so that they may be processed. In some embodiments, a partial decoding is taken so that a large memory size is not required. Indeed, each video stream possesses a reasonable size in its coded standard format, which integrates a data compression scheme, but occupies a much greater size than its decoded format.

Next, at operation 245, the generated panoramic images corresponding to a given instant are then stitched to generate a wide field video stream. As explained above in detail at FIG. 1, the generation of the wide field video stream is carried out with the aid of the reference value of the construction parameters, which were calculated at operations 225 and 235. Furthermore, operations 240 and 245 are repeated until the completed wide field video stream is generated. As such, this particular method allows for a fast and efficient construction of the panoramic images and the corresponding wide field video stream. As such, it is possible to carry out a mathematical interpolation calculation based on the values of the construction parameters at all instants.

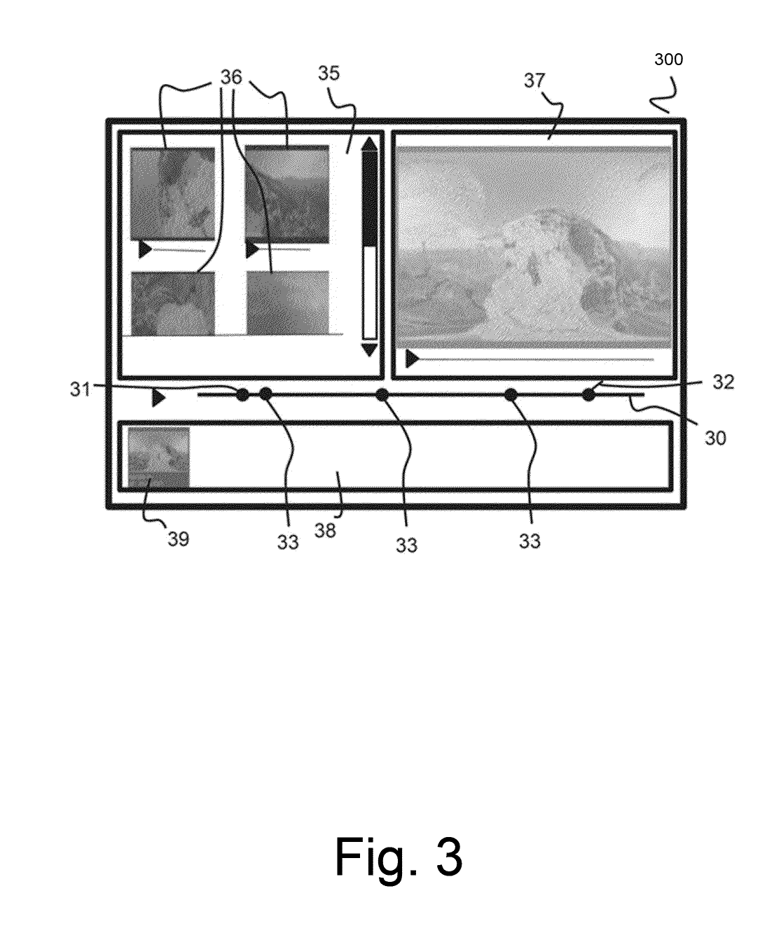

FIG. 3 illustrates a graphical human interface screen 300 for stitching various video source streams on a stitching device, in accordance with one or more implementations. The graphical human interface screen 300 may be configured to position the various source video streams to be stitched to create a wide field video stream. The human machine interface 300 of the stitching device, as discussed in detail in FIG. 1, may be configured to include a processor. As illustrated, the graphical human interface screen 300 incudes a window 35 where the operator can select and position the various source video streams to be stitched. Additionally, each source video stream may be viewed in full in an independent manner prior to the stitching of the various source video streams within window 35. Each source video stream may be added or removed from the window 35. The operator may manually search in the memory space of the corresponding stitching device of the window 35 to select the source video streams to be added or select the source video streams from another window (not shown) and move them into window 35. Additionally, the operation may select the various source video streams and delete them from the window 35 by selecting the delete button or moving them manually out of the window 35 space.

Moreover, the graphical human interface screen 300 allows an operator to choose the temporal limits of the stitching of the source video streams, such as the start and end of the stitching instants. Accordingly, the human machine interface 300 presents a time line 30 to the operator such that the operator can position a first cursor 31 and a second cursor 32 to indicate and assign the start and end instants of the wide field video stream to be generated.

To undertake the calculation of the reference instants and the reference parameters, the operator can further add a third cursor 33 on the time line 30 to define the reference instant. Upon the determination of the reference instant, the stitching device may produce a panoramic image among the selected images at the chosen reference instants of the various video streams. A panoramic image 39 may then be obtained and displayed simultaneously or successively in a display zone 38 of the graphical human interface screen 300.

In the instance that the generated panoramic image 39 is not satisfactory or the operator wishes to undertake a different stitching, the operator may move at least the third cursor 33 to define another set of reference instants and redo the panoramic image generation. As such, the operator may select a new reference instant until a satisfactory result is achieved through a simple visual inspection in the displace zone 38. The operator may be select the best quality result thus guaranteeing an advantageous choice of the panoramic construction parameters.

Additionally, the operator can open another menu within the human-machine interface where the operator can then modify the construction parameters for the stitching of the images for each source video stream, as to refine the generated panoramic image result displayed in display zone 38.

The generated wide field video stream generated from the stitching of the plurality of the corresponding panoramic images may then be displayed in a wide field video visualization window 37. The wide field video visualization window 37 may allow the simple viewing of the generated wide field video stream.

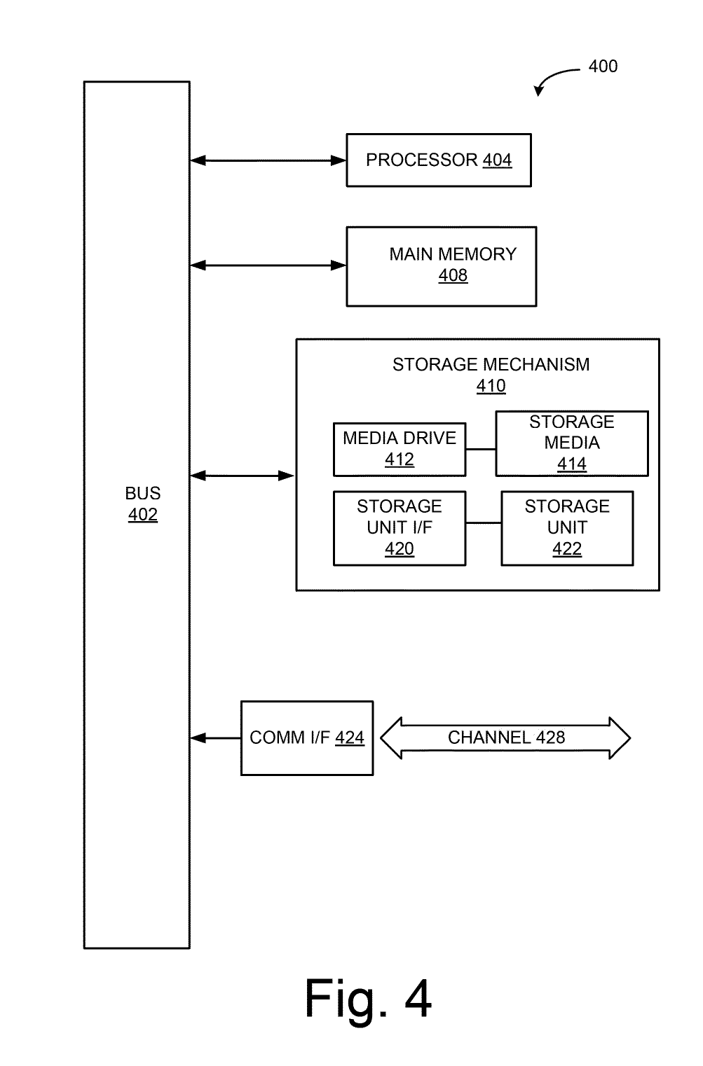

Referring now to FIG. 4, computing module 400 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally.

Computing module 400 might also include one or more memory modules, simply referred to herein as main memory 408. For example, preferably random access memory (RAM) or other dynamic memory, might be used for storing information and instructions to be executed by processor 404. Main memory 608 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid state drive, a magnetic tape drive, an optical disk drive, a CD or DVD drive (R or RW), or other removable or fixed media drive might be provided. Accordingly, storage media 414 might include, for example, a hard disk, a solid state drive, magnetic tape, cartridge, optical disk, a CD or DVD, or other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and a storage interface 420. Examples of such storage units 422 and storage interfaces 420 can include a program cartridge and cartridge interface, a removable memory (for example, a flash memory or other removable memory module) and memory slot, a PCMCIA slot and card, and other fixed or removable storage units 422 and storage interfaces 620 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 408, storage unit 420, media 414, and channel 428. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 600 to perform features or functions of the present application as discussed herein.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiment

What is claimed is:

1. A method for stitching a plurality of video streams, comprising:
obtaining multiple video streams that correspond to a common period in time at which at least portions of individual video streams in the multiple video streams were captured;
determining at least one reference instant within the common period of time;
calculating a reference value of a construction parameter of one or more images from the multiple video streams captured at times that correspond to the determined reference instant; and
constructing a panoramic image by stitching together the images of the multiple video streams captured at times corresponding to the determined reference instant as part of creating a wide field video stream, such that the stitching is based on the reference value of the construction parameter.

2. The method of claim 1, further comprising:
selecting a panoramic image construction algorithm defining a plurality of geometric and radiometric construction parameters;
calculating the reference value at a first reference instant from the panoramic image construction algorithm;
calculating a reference value at other instants on the basis of the reference values of the construction parameter; and
stitching together the multiple video streams corresponding to a same reference instant.

3. The method of claim 1, wherein the construction parameters are held constant for the duration of the stitching of the multiple video streams.

4. The method of claim 3, wherein at least one of the construction parameters varies for at least a portion of the duration of the stitching of the multiple video streams.

5. The method of claim 3, wherein at least one of the construction parameters is obtained by a mathematical interpolation of a basis of at least two reference values of the construction parameter calculated at two different reference instants to obtain a continuous progression of time with respect to at least one construction parameter.

6. The method of claim 1, wherein the construction of the panoramic images further comprises using the reference values of the construction parameters at different reference instants.

7. The method of claim 1, wherein the reference values of the construction parameters is determined by calculating the mathematical interpolation of at least two reference values for two reference instants for a determined time interval.

8. The method of claim 7, wherein the mathematical interpolation comprises linear, Bezier, cubic, spline, or b-spline interpolation.

9. The method of claim 1, further comprising:
partially decoding the video streams at the determined reference instant; and
stitching together the panoramic images of the video streams corresponding to the reference instant and reference value of the construction parameter.

10. The method of claim 1, wherein calculating the reference value of the construction parameters at the reference instant further comprises modifying the construction parameters corresponding to at least two different camera viewpoint orientations to ensure a horizon is kept stable in the wide field video stream.

11. The method of claim 1, further comprising:
defining various reference instants based on manual or automatic selection, such that the various reference instants correspond to a common period of time; and
defining reference values of the construction parameters for various reference instants,
wherein the reference values are defined by combining the construction parameters obtained at various reference instants.

12. The method of claim 1, further comprising combining the images of the video streams at the determined reference instant in a display zone of a human-machine interface;
wherein the determined reference instant is input into the human-machine interface by an operator.

13. The method of claim 1, further comprising:
measuring a temporal offset of the multiple video streams with respect to time; and
synchronizing the multiple video streams by associating the images captured at proximate times within the various video streams.

14. The method of claim 13, wherein measuring the temporal offset of the multiple video streams further comprises identifying a soundtrack associated with the various video streams to identify sounds to further synchronize the multiple video streams in accordance to the soundtrack.

15. The method of claim 1, further comprising displaying the wide field video stream on a display space of at least one screen.

16. A stitching device for stitching a plurality of video stream comprising:
a processor
a non-transitory computer-readable medium operatively coupled to the processor and storing instructions that, when executed, cause the processor to:
obtain multiple video streams that correspond to a common period in time at which at least portions of individual video streams in the multiple video streams were captured;
determine at least one reference instant within the common period of time;
calculate a reference value of a construction parameter of one or more images from the multiple video streams at the determined reference instant; and
construct a panoramic image by stitching together the images of the multiple video streams corresponding to the determined reference instant, such stitching based on the reference value of the construction parameter.

17. A stitching device of claim 16, further comprising an interface for inputting at least one reference instant to calculate the reference value of the construction parameter.

18. A stitching device of claim 16, further comprising:
a first window for presenting the various video streams to be stitched;
a second window for viewing the panoramic image resulting from the stitching of the images of the various video streams at a determined reference instant;
a select area for inputting the determined reference instant; and
a third window for presenting a wide field video stream created from stitching the various video streams.

19. The system for stitching a plurality of video streams, comprising:
a camera holder comprising at least two adjacent housings to fasten at least a first and a second camera such that the cameras are oriented substantially perpendicular to one another; and
a stitching device with a anon-transitory computer-readable medium operatively coupled to a processor and storing instructions that, when executed, cause the processor to stitch various video streams filmed from at least the first and the second camera from the camera holder.

20. The system of claim 19, further comprising an integrated reader to view the wide field video stream on a screen of the stitching device.
